(19) United States
(12) Patent Application Publication
(10) Pub. No.: US 2026/0168724 A1
(43) Pub. Date: Jun. 18, 2026

(54) CABINET AND HOME APPLIANCE HAVING THE SAME

(71) Applicant: LG Electronics Inc., Seoul (KR)

(72) Inventors: Chungseob LEE, Seoul (KR); Hyunwoo PARK, Seoul (KR); Wonho PARK, Seoul (KR); Namgyo LEE, Seoul (KR)

(21) Appl. No.: 19/425,200

(22) Filed: Dec. 18, 2025

(30) Foreign Application Priority Data
Dec. 18, 2024 (KR) 10-2024-0189866

(51) Int. Cl. F25D 23/02; E05F 1/12

(52) U.S. Cl. CPC F25D 23/028; E05F 1/12; E05Y 2900/31; F25D 2323/024

(57) ABSTRACT

A cabinet includes: a cabinet body having a storage space; a door that opens and closes the storage space; a hinge device configured to allow the door to rotate relative to the cabinet; and a height adjusting member configured to adjust a height of the door. The hinge device includes a hinge body installed at the cabinet, a pin unit provided at the hinge body, and a guide member provided at the door and forming a pin slot in which the pin unit is received. The height adjusting member is movably coupled to the guide member, when the height adjusting member moves in a first direction, a height of the door is decreased, and when the height adjusting member moves in a second direction, the height of the door is increased.

### CROSS-REFERENCE TO RELATED APPLICATIONS

This application claims the benefit of Korean Patent Application No. 10-2024-0189866, filed on Dec. 18, 2024. The disclosure of the prior application is incorporated by reference in its entirety.

### BACKGROUND

The present disclosure relates to a cabinet and toa home appliance, in particular to a refrigerator or clothes treatment device, having the same.

In general, a refrigerator is a home appliance for storing foods in an internal storage space, which is shield by a door, at a low temperature by low temperature air. For this, the refrigerator is configured to accommodate the food in an optimum state by cooling the internal storage space using cold air generated through heat exchange with a refrigerant circulating in a refrigeration cycle.

The refrigerator may be independently placed in a kitchen or living room or may be a built-in home appliance that is accommodated in a space defined by a furniture cabinet or surrounding cabinets of the kitchen.

The refrigerator may include a cabinet including a body forming a storage space and a door connected to the cabinet to open and close the storage space.

For example, if the refrigerator is installed inside the furniture cabinet, there is a risk that the door may hit the furniture cabinet during an opening process, which may limit an opening angle of the door. Of course, this situation may also apply to other home appliances than a refrigerator, e.g. to a clothes treatment device such as a refresher, styler, washing machine or dryer.

Recently, a hinge structure has been developed to prevent the door from interfering with surrounding structures such as a furniture cabinet during a door opening process.

There is a prior art document of International Publication No. WO2019/007278A1.

Meanwhile, a height adjustment of doors may be necessary to ensure that heights of multiple doors in a refrigerator are consistent.

There is a prior art document of Korean Patent Publication No. 10-2021-0123087.

### SUMMARY

It is an object of the present disclosure to provide a cabinet, e.g. a cabinet for a home appliance, in particular for a refrigerator or clothes treatment device, and a home appliance, in particular to a refrigerator or a clothes treatment device, having the same, wherein a door height can be easily adjusted.

It is an object of the present disclosure to provide a cabinet, e.g. a cabinet for a home appliance, in particular to a refrigerator or a clothes treatment device, and a home appliance, in particular to a refrigerator, having the same, that is configured to prevent interference with surrounding structures during a door opening process while increasing a door opening angle.

It is an object of the present disclosure to provide a cabinet, e.g. a cabinet for a home appliance, in particular to a refrigerator or a clothes treatment device, and a home appliance, in particular to a refrigerator, having the same, wherein a door can be automatically closed by an auto-closing device during a door closing process, and a structure for a height adjustment is prevented from interfering with the auto closing device.

According to one aspect of the present disclosure, a cabinet, in particular a cabinet for a home appliance, is provided, wherein the cabinet includes: a cabinet body defining a storage space and a door for opening and closing the storage space; a hinge device to allow the door to rotate relative to the cabinet; and a height adjusting member configured to adjust a height of the door.

According to one aspect, a home appliance, in particular a refrigerator or a clothes treatment device, includes a cabinet having a cabinet body defining a storage space and a door for opening and closing the storage space; a hinge device to allow the door to rotate relative to the cabinet body; and a height adjusting member configured to adjust a height of the door.

According to one aspect, a home appliance, in particular a refrigerator or a clothes treatment device, my includes a cabinet having a storage space; a door that opens and closes the storage space; a hinge device to allow the door to rotate relative to the cabinet; and a height adjusting member to adjust a height of the door.

According to one aspect, a home appliance, in particular a refrigerator or a clothes treatment device, includes a cabinet having a storage space; a door that opens and closes the storage space; a hinge device to allow the door to rotate relative to the cabinet; and a height adjusting member to adjust a height of the door. The hinge device includes a hinge body installed at the cabinet, a pin unit provided at the hinge body, and a guide member provided at the door and forming a pin slot in which the pin unit is received. The height adjusting member is movably coupled to the guide member, such that when the height adjusting member moves in a first direction, a height of the door decreases, and when the height adjusting member moves in a second direction, the height of the door increases.

According to one aspect, a cabinet for a home appliance, in particular for a refrigerator or a clothes treatment device, comprises: a cabinet body having a storage space; a door for opening and closing the storage space; a hinge device installed at the cabinet body and rotatably coupling the door to the cabinet body; and a height adjusting member coupled to the door, in particular to a door frame, and configured to adjust a height of the door with respect to the cabinet body; and a guide member supported by (or abutting on) the hinge device; wherein the height adjusting member is movably coupled to (or engaged with) the guide member to be movable in vertical direction with respect to the guide member and/or to the hinge device and/or to the cabinet body. By these means, a change in (vertical) position of the height adjusting member may correspond to a change in height of the door.

The cabinet and the home appliance having the same according to any one of these aspects may include one or more of the following features:

The door may have a vertical rotation axis. A height of the door may be a vertical position of the door, e.g. with respect to (the body of) the cabinet.

The hinge device may include a hinge body installed at the (body of the) cabinet. The guide member may be supported by, e.g. may abut on, the hinge body, e.g. on an extension of the hinge body. The hinge device may include a pin unit. The pin unit may be provided at the hinge body. A/The guide member may be provided at the door and/or may form a pin slot in which the pin unit is received.

The height adjusting member may be movably coupled to or engaged with the guide member. When the height adjusting member moves in a first direction (e.g. downwards), a height of the door may decrease, and when the height adjusting member moves in a second direction (e.g. upwards), the height of the door may increase. The height adjusting member may be coupled to the door such that a change in (vertical) position of the height adjusting member may correspond to a change in height of the door. The height adjusting member may be coupled to the door at a fixed relative position in vertical direction, e.g. by means of a support plate coupled to a door frame of the door. During a door opening process, relative positions of the pin slot and the pin unit may be changed, e.g. in a horizontal plane, thereby moving a rotation center or rotation axis of the door, e.g. in the horizontal plane. The pin slot may extend in a horizontal plane.

The guide member may include a coupling slot to which the height adjusting member is coupled. The guide member may include a pin slot in which the pin unit is received. The guide member may include a first body in which the pin slot is formed, and a second body including a coupling slot to which the height adjusting member is coupled.

A screw thread may be formed on an outer circumferential surface of the height adjusting member, and a screw thread that interacts with the screw thread of the height adjusting member may be formed on a surface forming the coupling slot.

When a (vertical) side surface of the door closest to the hinge device among both side surfaces of the door is referred to as a first side surface, at least a portion of the height adjusting member may be positioned farther from the first side surface of the door than the pin slot and/or the pin unit. Here, the side surface(s) may extend vertically, i.e. may refer to left and/or right side surfaces of the door. The side surface(s) may extend perpendicular to the front and/or rear surface of the door and/or may connect the front surface and the rear surface to each other.

A portion of the pin slot and/or the pin unit may be positioned closer to a front surface of the door than the height adjusting member. Another portion of the pin slot and/or the pin unit may be positioned closer to a rear surface of the door than the height adjusting member. Here, the rear surface of the door may denote a surface of the door facing the storage space in a closed state of the door. The front and rear surface may be opposite to each other.

The door may further include an auto closing device provided at one side of the guide member of the door and/or configured to provide closing force to the door during a door closing process. The auto closing device may include a body installed at the door at one side of the guide member and a lever rotatable with respect to the body and interacting with the hinge body. At least a portion of the height adjusting member may be positioned closer to the pin slot and/or the pin unit than a rotation center of the lever.

At least a portion of the height adjusting member may be positioned between the auto closing device and the pin slot and/or the pin unit.

At least a portion of the auto closing device may be positioned between the height adjusting member and the pin slot and/or the pin unit.

The height adjusting member may be positioned closer to the rear surface of the door than the pin slot and/or the pin unit.

When a side surface of the door closest to the hinge device among both side surfaces of the door is referred to as a first side surface, the second body may extend from a point on the first body toward the first side surface or a rear surface of the door.

The pin unit may include at least one pin. When the pin unit includes only one pin, the pin slot may be formed as a (circular) hole. When the pin unit includes two pins, the pin slot may be formed as an arch shaped and/or elongated slot. In this case, a rotation center or axis of the door may be moved, e.g. in a horizontal plane, during an opening or closing process of the door. The pin unit may include a first pin and a second pin. The pin unit, in particular the first and second pins, may extend vertically from the hinge body, in particular from an extension of the hinge body. The second pin may be closer to the first side surface than the first pin.

The pin slot may include a first end with which the first pin contacts or is adjacent in a state in which the door is closed, and a second end with which the second pin contacts or is adjacent in a state in which the door is opened to a maximum opening angle. In a state in which the door is opened to a maximum opening angle, the first pin may be spaced apart from the first end, and in a state in which the door is closed, the second pin may be spaced apart from the second end. At least a portion of the height adjusting member may be positioned between the first end and the second end. The height adjusting member or at least a portion thereof may be positioned adjacent to the first end of the pin slot.

The first end may be positioned closer to a front surface of the door than the second end. At least a portion of the height adjusting member may be positioned closer to the front surface of the door than the second end, and/or at least a portion of the height adjusting member may be positioned farther from the front surface of the door than the first end. At least a portion of the height adjusting member may be positioned closer to the rear surface of the door than the first end and/or the second end.

The door may include a door frame and/or a cover plate. The cover plate may extend through the door frame, e.g. through an opening in the door frame.

The door may include a support plate coupled to the door, in particular to the door frame and/or to a cover plate of the door. The support plate may be rotatably supporting the height adjusting member. The support plate may be coupled to the height adjusting member such that the height adjusting member is rotatable, e.g. about a vertical axis, and/or such that a relative position of the height adjusting member and the support plate in vertical direction (and/or a relative position of the height adjusting member and the door in vertical direction) is fixed. The height adjusting member may be (rotatably) coupled to the support plate. The height adjusting member may include a recess at an end thereof, the support plate being inserted in the recess. The height adjusting member may extend in vertical direction and/or the recess of the height adjusting member may be formed in horizontal direction. The support plate and the door (frame) may be fixedly connected to each other, e.g. by means of at least one coupling member.

The height adjusting member may include a first member coupled to the guide member, e.g. by means of threaded coupling, and/or a second member coupled to or rotatably supported by the support plate. The second member may include a/the recess.

The support plate may include a coupling groove formed by recessing one surface of the support plate into which the height adjusting member is inserted and/or to allow the height adjusting member to be coupled. The recess of the height adjusting member may be inserted in the coupling groove, thereby coupling the height adjusting member to the support plate. The support plate may include a coupling groove formed by recessing one surface to allow the second member to be coupled, i.e. to couple with the recess of the second member. A vertical movement of the height adjusting member may be transferred to the support plate, e.g. by the first and third member.

The second member may include a first part (e.g. having a first diameter), a second part extending from the first part and having a second diameter, and a third part extending from the second part and having a third diameter. The second part may extend from the first part in a vertical direction and/or in a direction away from the first member. The second part may be disposed between the first part and the third part. The first to third parts of the height adjusting member may be aligned and/or disposed in vertical direction. The third diameter may be larger than the second diameter. In other words, the third part may support the support plate such that a vertical (upward) movement of the height adjusting member is transferred to the support plate (and the door).

The recess or second part may be received in the coupling groove. The first diameter and the third diameter may be greater than the second diameter. The first diameter and the third diameter may be greater than a width or size of the coupling groove. The first to third parts may form the recess of the height adjusting member.

The support plate may include a hole through which the guide member passes, e.g. through which at least a portion of the guide member, in particular at least a portion of the first body, passes. The support plate may be movable with respect to the guide member in vertical direction, e.g. along an outer surface of the guide member.

The door frame may include a receiving space (also denoted as second space) in which the guide member is received. The guide member may be movable within the receiving space in vertical direction. The receiving space may be configured to couple a rotation of the guide member in the horizontal plane to the door (frame). In other words, a relative position of the guide member and the door frame in both horizontal directions may be fixed.

The support plate may include a stopper that restricts a rotation of the door when the door is opened at a certain angle. The support plate may extend in the horizontal plane and/or the stopper may extend in vertical direction. The stopper may have a plate shape extending in parallel to the front surface of the door.

The door may further include a reinforcing plate. The reinforcing plate may be connected to a coupling member passing through the support plate. A portion of the door frame may be interposed between the reinforcing plate and the support plate. At least two of the support plate, the door frame and the reinforcing plate may be fixedly connected to each other, e.g. by means of at least one coupling member.

According to another aspect, a home appliance, in particular a refrigerator, may include: a cabinet having a storage space; a door that opens and closes the storage space; a hinge device to allow the door to rotate relative to the cabinet; a height adjusting member to adjust the height of the door; and an auto closing device to provide a closing force to the door during a door closing process.

The hinge device may include a hinge body installed at the cabinet, a pin unit provided at the hinge body, and a guide member provided at the door and forming a pin slot in which the pin unit is received.

The auto closing device may include a body installed at the door at one side of the guide member and a lever rotatable with respect to the body and interacting with the hinge body. At least a portion of the height adjusting member may be positioned closer to the pin slot than a rotation center of the lever. Alternatively, at least a portion of the auto closing device may be positioned between the height adjusting member and the pin slot.

The height adjusting member may be movably coupled to the guide member.

The door may further include a support plate coupled to the door and rotatably supporting the height adjusting member.

According to another aspect, a home appliance, in particular a refrigerator or a clothes treatment device, includes: a cabinet having a storage space; a door that opens and closes the storage space; a hinge device to allow the door to rotate relative to the cabinet; a height adjusting member to adjust the height of the door; and an auto closing device to provide a closing force to the door during a door closing process. The hinge device includes a hinge body installed at the cabinet, a pin unit provided at the hinge body, and a guide member provided at the door and forming a pin slot in which the pin unit is received. The auto closing device includes a body installed at the door at one side of the guide member and a lever rotatable with respect to the body and interacting with the hinge body. At least a portion of the height adjusting member is positioned closer to the pin slot than a rotation center of the lever.

According to another aspect, a home appliance, in particular a refrigerator or a clothes treatment device, includes: a cabinet having a storage space; a door that opens and closes the storage space; a hinge device to allow the door to rotate relative to the cabinet; a height adjusting member to adjust the height of the door; and an auto closing device to provide a closing force to the door during a door closing process. The hinge device includes a hinge body installed at the cabinet, a pin unit provided at the hinge body, and a guide member provided at the door and forming a pin slot in which the pin unit is received. The auto closing device includes a body installed at the door at one side of the guide member and a lever rotatable with respect to the body and interacting with the hinge body. At least a portion of the auto closing device is positioned between the height adjusting member and the pin slot.

The configuration described above for a home appliance, in particular for a refrigerator, can be applied to a cabinet in general, not only to a cabinet for a home appliance, as well.

According to one embodiment, a height adjusting member can be operated by connecting a tool to a lower portion of the door while the door is opened, a height of the door can be easily adjusted.

According to one embodiment, a rotation center moves during a door opening process, thereby increasing an opening angle of the door while preventing interference with surrounding structures.

According to one embodiment, the vertical position or height of the door connected to the height adjusting member is adjusted by rotating the height adjusting member, so there is an advantage in that a structure for adjusting the height of the door is simplified.

According to one embodiment, the door can be automatically closed by an auto closing device during a door closing process, and the height adjusting member for height adjustment is connected to a guide member to which the pin unit is coupled, so that the height adjusting member has the advantage of being compact without interfering with the auto closing device.

Of course, the present invention may be applied to other home appliances than a refrigerator, e.g. to a clothes treatment device such as a refresher, styler, washing machine or dryer.

### BRIEF DESCRIPTION OF THE DRAWINGS

FIG. 1 is a perspective view of a refrigerator according to a first embodiment.

FIG. 2 is a drawing showing a first hinge device in a state in which a first door is opened according to a first embodiment.

FIG. 3 is an exploded perspective view showing a door frame, a height adjusting member, and a first hinge device according to a first embodiment.

FIG. 4 is an exploded perspective view of structures coupled to a door frame according to a first embodiment.

FIG. 5 is a top perspective view of a door frame according to a first embodiment.

FIG. 6 is a bottom perspective view of a door frame according to a first embodiment.

FIG. 7 is a rear perspective view of a door frame showing a state in which a reinforcing plate and a cover plate are coupled to a door frame according to a first embodiment.

FIG. 8 is a front perspective view of a door frame showing a state in which a reinforcing plate and a cover plate are coupled to a door frame according to a first embodiment.

FIG. 9 is a cross-sectional view taken along line 9-9 of FIG. 7.

FIG. 10 is a cross-sectional view taken along line 10-10 of FIG. 7.

FIG. 11 is a drawing showing a tool connected to a height adjusting member according to a first embodiment.

FIGS. 12 and 13 are drawings showing relative positions of a guide member and a door frame while a height of a first door is adjusted according to a first embodiment.

FIG. 14 is a bottom view of a first door showing a position of a height adjusting member according to a second embodiment.

FIG. 15 is a plan view of a door frame according to a second embodiment.

FIG. 16 is a perspective view of a guide member according to a second embodiment.

FIG. 17 is a perspective view of a guide member according to a third embodiment.

FIG. 18 is a plan view of a door frame according to a fourth embodiment.

FIG. 19 is a drawing showing a lower side of a first door according to a fourth embodiment.

FIG. 20 is a drawing showing a guide member and a height adjusting member according to a fourth embodiment.

FIG. 21 is a drawing showing a lower side of a first door according to a fifth embodiment.

FIG. 22 is a drawing showing a hinge device according to a sixth embodiment.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or jointed to the latter or may be “connected”, coupled” or “joined” to the latter with a third component interposed therebetween.

Hereinafter, a refrigerator is described as an example of a home appliance, but it should be noted that a structure for rotating a door and a height adjusting device can be applied equally to other home appliances besides the refrigerator, and even to a cabinet having the door in general.

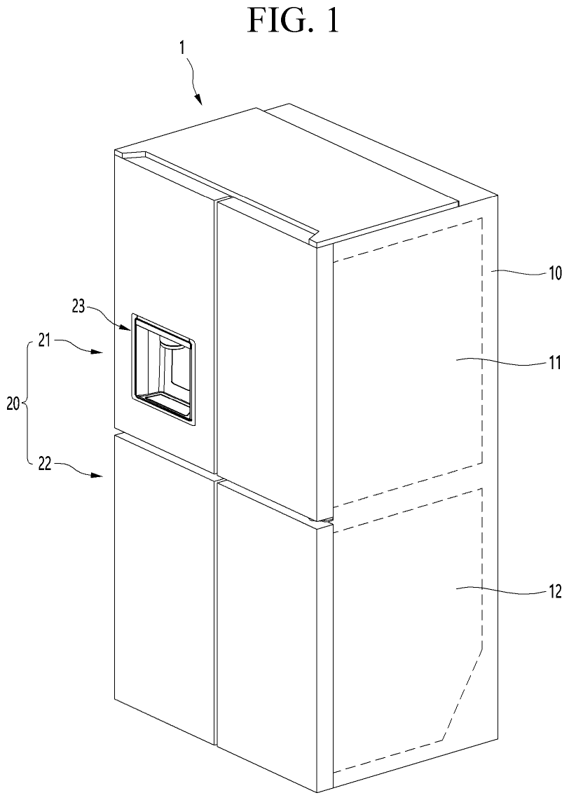

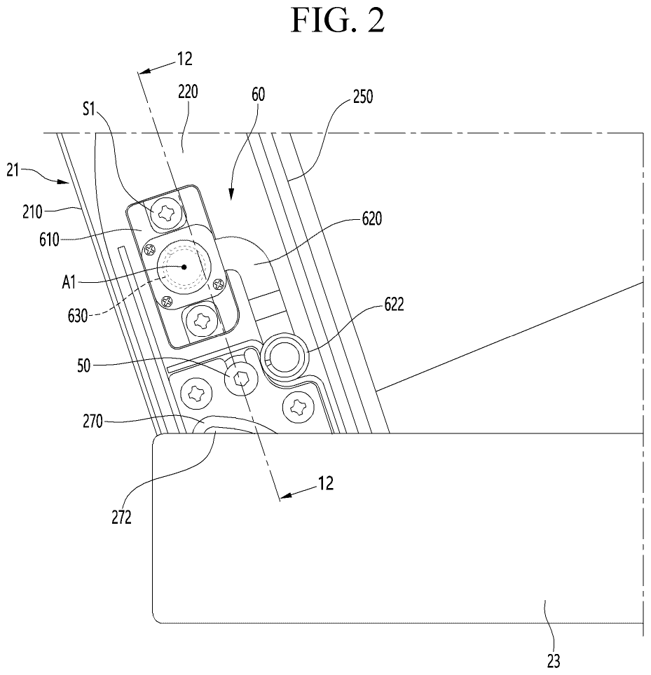

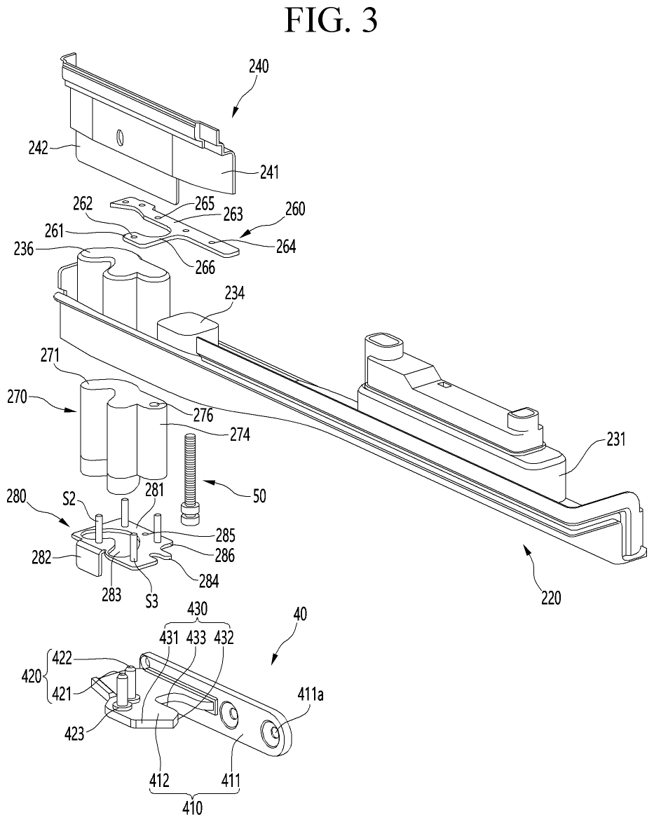

FIG. 1 is a perspective view of a refrigerator according to a first embodiment. FIG. 2 is a drawing showing a first hinge device in a state in which a first door is opened according to a first embodiment. FIG. 3 is an exploded perspective view showing a door frame, a height adjusting member, and a first hinge device according to a first embodiment.

Referring to FIGS. 1 to 3, a refrigerator 1 according to the present embodiment may be independently installed at a kitchen or accommodated within an indoor furniture cabinet (hereinafter collectively referred to as a “furniture cabinet”).

When the refrigerator 1 is installed within an indoor furniture cabinet, a refrigerator 1 may be installed independently or arranged left and right with another refrigerator.

The refrigerator 1 may include a cabinet having a storage space. The cabinet may have a cabinet body 10 defining the storage space. The refrigerator 1, or the cabinet, may further include a door 20 that opens and closes the storage space.

The storage space may be divided into, but is not limited to, a first space 11 at an upper side and a second space 12 at a lower side. The door 20 may also include a first door 21 than opens and closes the first space and a second door 22 that opens and closes the second space.

The first space may be a refrigerating chamber and the second space may be a freezing chamber, or vice versa. Alternatively, the storage space may include a first space and a second space divided left and right. Alternatively, the storage space may be a single space, and a single door may open and close the storage space.

At least one of the first door 21 or the second door 22 may be a rotary door. Alternatively, a single door 20 may be a rotary door. Hereinafter, a rotary type door 20 will be described, with the first door 21 as an example.

In the present embodiment, the first door 21 may be rotatably connected to the body 10 of the cabinet by a hinge device.

The hinge device may include a first hinge device 40 positioned at a lower side of the first door 21 and a second hinge device positioned at an upper side of the first door 21. The first hinge device 40 and the second hinge device have the same structure for a rotation of the first door 21, but differ in the structure for installation in the cabinet, for example, a shape or structure of a hinge body. Hereinafter, the first hinge device 40 will be described as an example.

The first door 21 may include a pair of doors arranged left and right. Exteriors of the pair of doors may be formed in a symmetrical shape. Furthermore, each of the pair of doors may be rotatably connected to the body 10 of the cabinet by a hinge device.

One of the pair of doors may be provided with a dispenser 23 for dispensing water and/or ice. Of course, the dispenser 23 may be omitted.

The first door 21 may include a front panel 210 to form a front exterior. The first door 21 may further include a door frame 220 coupled to the front panel 210 and forming a lower exterior of the first door 21. The first door 21 may further include a door liner 250 forming a rear exterior and connected to the door frame 220.

The front panel 210, the door liner 250, and the door frame 220 may form an insulation space in which an insulator is received. The insulator may be a vacuum insulator or may be formed as a foaming solution injected into the insulating space hardens.

The first hinge device 40 may include a hinge body 410. The hinge body 410 may be coupled to one surface of the body 10 of the cabinet. The one surface may be, for example, a front surface of the body 10 of the cabinet. A portion of the hinge body 410 may overlap a lower side of the first door 21 in a vertical direction.

The hinge body 410 may support a load of the first door 21. The hinge body 410 may include, for example, a coupling portion 411 coupled to the body 10 of the cabinet and an extension 412 extending from the coupling portion 411.

The coupling portion 411 may be coupled to, for example, a front surface of the body 10 of the cabinet. One or more coupling holes 411a to which a coupling member is coupled may be formed in the coupling portion 411.

When the refrigerator 1 is installed in the furniture cabinet or in the kitchen, an opening angle of the first door 21 needs to be increased without interfering with the furniture cabinet or surrounding structures during an opening process of the first door 21.

In the present embodiment, the opening angle of the first door 21 can be increased without interfering with a furniture cabinet or surrounding structures by the first hinge device 40 and the second hinge device. For example, the first hinge device 40 and the second hinge device may cause a rotation center of the first door 21 to be moved in at least a period among an entire opening period of the first door 21.

The first hinge device 40 described below can be equally applied to the second door 22 when the second door 22 is of a rotation type.

The first hinge device 40 may further include a pin unit 420.

The pin unit 420 may include a first pin 421 and a second pin 422. The first pin 421 and the second pin 422 may be spaced apart from the hinge body 410. The first pin 421 and the second pin 422 may be formed integrally with the hinge body 410 or may be coupled to the hinge body 410.

The first pin 421 and the second pin 422 may extend from the hinge body 410 in parallel and/or toward the first door 21, for example. The first pin 421 and the second pin 422 may extend upward from the hinge body 410. For example, the pin unit 420 may be provided at the extension 412.

The second hinge device may also include a first pin and a second pin, and the first pin 421 and the second pin 422 of the first hinge device 40 may be aligned vertically with the first pin and the second pin of the second hinge device. However, the hinge body of the second hinge device may be installed on an upper surface of the body 10 of the cabinet.

The first door 21 may further include a pin slot 272 in which the pin unit 420 is received. The pin slot 272 may be provided at a lower side of the first door 21. The pin slot 272 may be formed as a lower surface of the first door 21 to be recessed upward. Alternatively, the pin slot 272 may be formed by a guide member 270. That is, the guide member 270 may include a pin slot 272 in a recessed shape. The guide member 270 may be coupled to a lower side of the first door 21. For example, the guide member 270 may be coupled to or integrated in the door frame 220.

The first pin 421 and the second pin 422 may be formed in a cylindrical shape. Alternatively, the first pin 421 and the second pin 422 may include a flange 423 having an expanding diameter. The flange 423 may be in contact with the hinge body 410. For example, each of first and second pins 421, 422 may include a first portion received in the pin slot 272, and a second portion (or flange) positioned at a lower side of the first portion and positioned outside the pin slot 272. The guide member 270 may be seated on the extension 412 or seated on the flange 423.

The pin slot 272 may include a curve. A curvature of the pin slot 272 may be gradually or continuously variable. When a curvature of the pin slot 272 is gradually variable, the pin slot 272 may be divided into a plurality of portions. A curvature of each of the plurality of portions may be different from each other.

The first door 21 may be opened in a state in which the first pin 421 and the second pin 422 are received in the pin slot 272. A rotation center of the first door 21 may be moved depending on a shape of the pin slot 272. The rotation center of the first door 21 may be, for example, a virtual rotation center. Depending on a shape of the pin slot 272, the rotation center may be moved continuously or gradually.

By moving the rotation center of the first door 21, an opening angle of the first door 21 may be increased without interfering with a furniture cabinet or surrounding structures during an opening process of the first door 21.

The refrigerator 1 may further include a support plate 280. The support plate 280 may be installed at a lower side of the first door 21. The support plate 280 may be installed at the door frame 220.

The support plate 280 may be formed of a material with high rigidity. For example, the support plate 280 may be formed of a metal material.

The support plate 280 may include a plate body 281. The plate body 281 may be coupled to the door frame 220 by coupling members S2 and S3.

The support plate 280 may include a stopper 282. The stopper 282 may limit a rotation of the first door 21 when the first door 21 is opened at a certain angle (e.g., a maximum opening angle).

The stopper 282 may be bent downward from the plate body 281. When the stopper 282 is in contact with a point of the extension 412 during an opening process of the first door 21, an opening of the first door 21 can be restricted. Of course, the stopper 282 can be omitted.

A hole 283 through which the guide member 270 passes may be formed in the plate body 281. When the support plate 280 is coupled to the first door 21, a portion of the guide member 270 may be positioned in the hole 283. Accordingly, the support plate 280 may surround an outer side of the guide member 270 and restrict movement or deformation of the guide member 270.

The support plate 280 may further include a coupling groove 284 formed in the plate body 281. The coupling groove 284 may be formed by being recessed in one surface of the plate body 281. For example, the coupling groove 284 may be formed by being recessed in one surface of the plate 281 toward the hole 283.

A height adjusting member 50, which will be described later, may be coupled to the coupling groove 284.

The support plate 280 may further include a coupling hole 285 for coupling with the first protrusion 226, which will be described later.

The support plate 280 may further include a groove 286 or a cutout to prevent interference with the auto closing device 60, which will be described later.

The refrigerator 1 may further include an auto closing device 60 that provides closing force to the first door 21 while the first door 21 is closed. Of course, the auto closing device 60 may be omitted.

The auto closing device 60 may be installed, for example, at the door frame 220.

The auto closing device 60 may provide closing force to the first door 21 while interacting with the hinge body 410 during a closing process of the first door 21.

The auto closing device 60 may be installed at the first door 21 at a position adjacent to the support plate or the guide member 270.

The auto closing device 60 may include a body 610 installed at the door frame 220. The body 610 may be coupled to the door frame 220 by coupling member S1.

The auto closing device 60 may further include a lever 620 movably installed at the body 610. For example, the lever 620 may be rotatable with respect to the body 610 based on a rotation center A1. The lever 620 may be movably connected to the body 610 while being elastically supported. For example, the auto closing device 60 may further include an elastic member 630 for elastically supporting the lever 620. The elastic member 630 may be directly or indirectly connected to the lever 620 within the body 610.

The lever 620 may further include a contact portion 622 to be in contact with the hinge body 410. The contact portion 622 may be, for example, a rotatable roller or a deformable member.

While the first door 21 is closed in a state in which the elastic member 630 connected to the lever 620 has accumulated elastic force, the elastic force acts as a closing force of the first door 21, so that the first door 21 can be automatically closed.

The extension 412 may include a contact surface 430 for interacting with the contact portion 622. The contact surface may include a first contact surface 431, a second contact surface 432, and a third contact surface 433. The second contact surface 432 may be inclined with respect to the first contact surface 431. The third contact surface 433 may be inclined with respect to the second contact surface 432.

In a state in which the first door 21 is opened at an angle greater than a set angle, the contact portion 622 does not in contact with the first contact surface 431. While the first door 21 is closed at an angle less than the set angle, the contact portion 622 may be in contact with the first contact surface 431.

While the first door 21 is closed, elastic force is accumulated in the elastic member 630 as the contact portion 622 moves along the first contact surface 431.

While the contact portion 622 moves along the second contact surface 432, the elastic force of the elastic member 630 acts as a closing force of the first door 21, so that the first door 21 can be automatically closed.

When the first door 21 is completely closed, the contact portion 622 may be in contact with the third contact surface 433.

The refrigerator 1 may further include a height adjusting member 50 to adjust a height of the first door 21. For example, a height of a lower surface of the first door 21 with respect to the extension 412 may be adjusted by the height adjusting member 50.

The height adjusting member 50 may be rotatably supported on the support plate 280. The height adjusting member 50 may be rotatably connected to the guide member 270.

The guide member 270 may include a first body 271 forming the pin slot 272.

The guide member 270 may further include a second body 274 to which the height adjusting member 50 is rotatably coupled. The second body 274 may, for example, extend in a horizontal direction from the first body 271.

The second body 274 may include a coupling slot 276 into which the height adjusting member 50 is inserted. The coupling slot 276 may be a groove or a hole. The coupling slot 276 may penetrate through the second body 274 or may be formed as a blind hole in the second body 274. The height adjusting member 50 may include a screw thread on an outer surface thereof, or may be configured as screw. The coupling slot 276 may include a screw thread on an inner surface thereof to engage with the screw thread of the height adjusting member 50, or may be configured as screw hole.

At least a portion of the height adjusting member 50 may be positioned closer to the pin slot 272 than a rotation center A1 of the lever 620.

The height adjusting member 50 will be described later with reference to the drawings.

The refrigerator 1 may include a reinforcing plate 260 to reinforce strength. The reinforcing plate 260 may be installed at the door frame 220.

The refrigerator 1 may further include a cover plate 240. The cover plate 240 may be coupled to the door frame 220.

The cover plate 240 may include a body portion 241 and a shield portion 242 extending from the body portion 241. The shield portion 242 may cover the stopper 282.

The shielding portion 242 may be positioned in front of the stopper 282 by passing through one surface of the door frame 220. As another example, it is also possible that a separate plate 240 does not exist and only the shielding portion 242 extends from the door frame 220. An exposure of the stopper 282 to a front of the first door 21 may be reduced by the shielding portion 242.

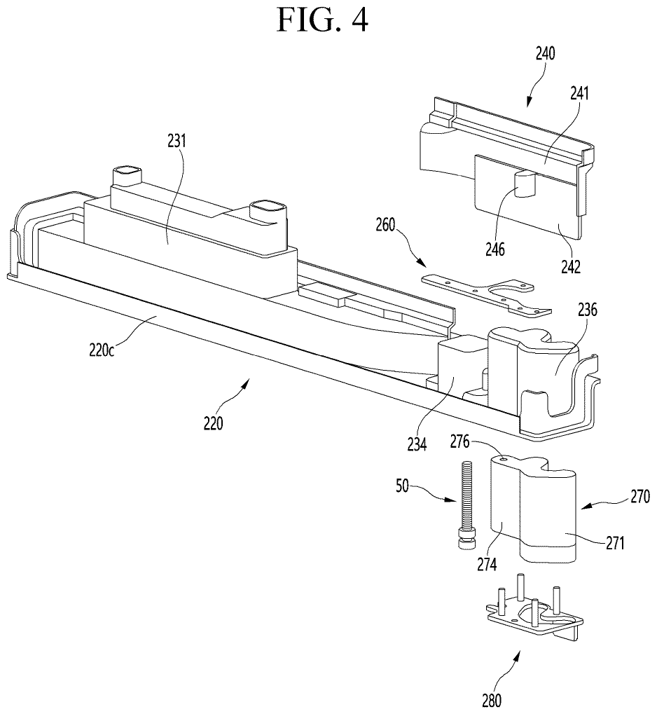

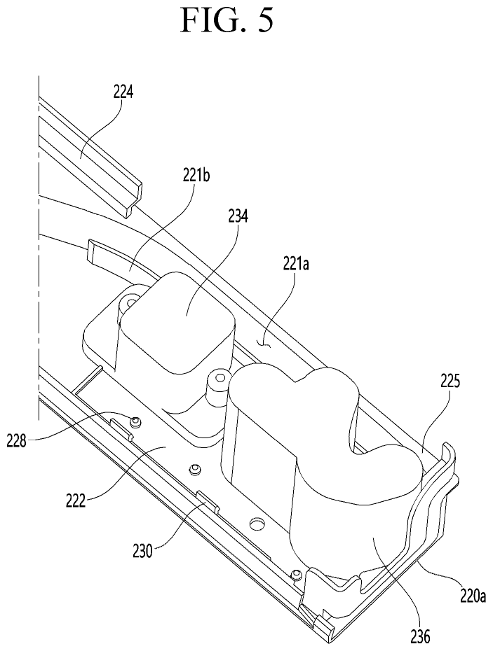

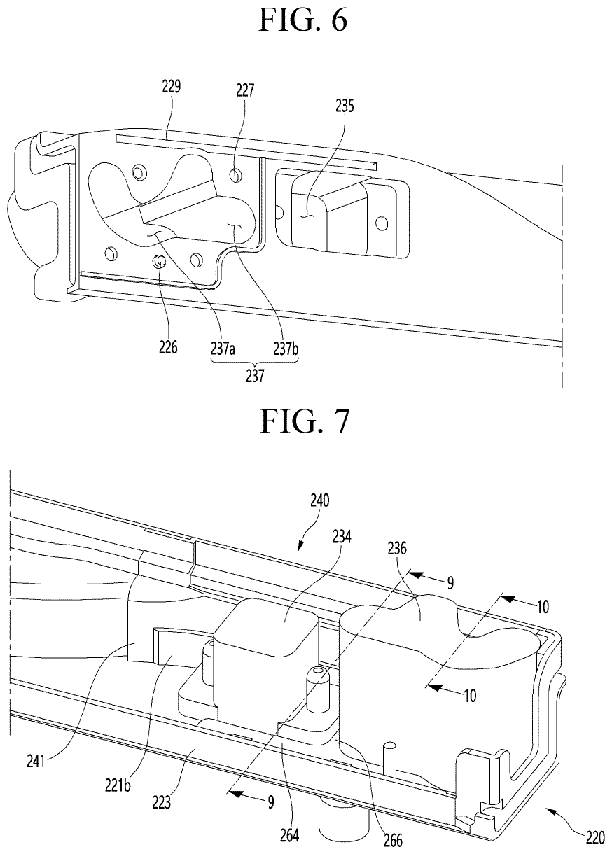

FIG. 4 is an exploded perspective view of structures coupled to a door frame according to a first embodiment. FIG. 5 is a top perspective view of a door frame according to a first embodiment. FIG. 6 is a bottom perspective view of a door frame according to a first embodiment.

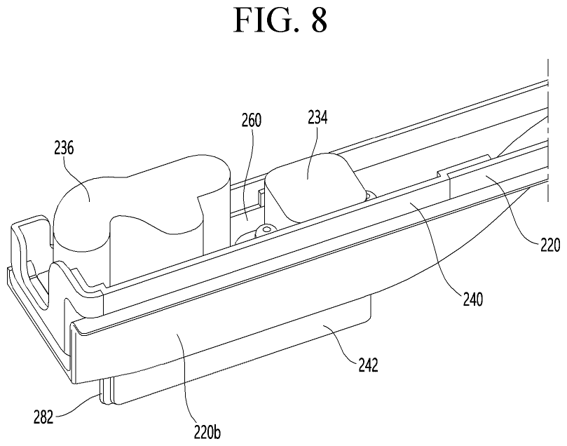

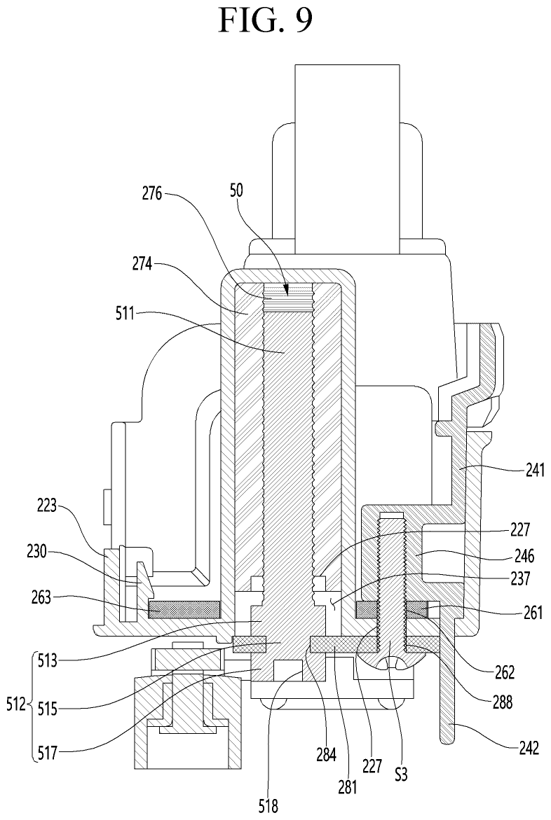

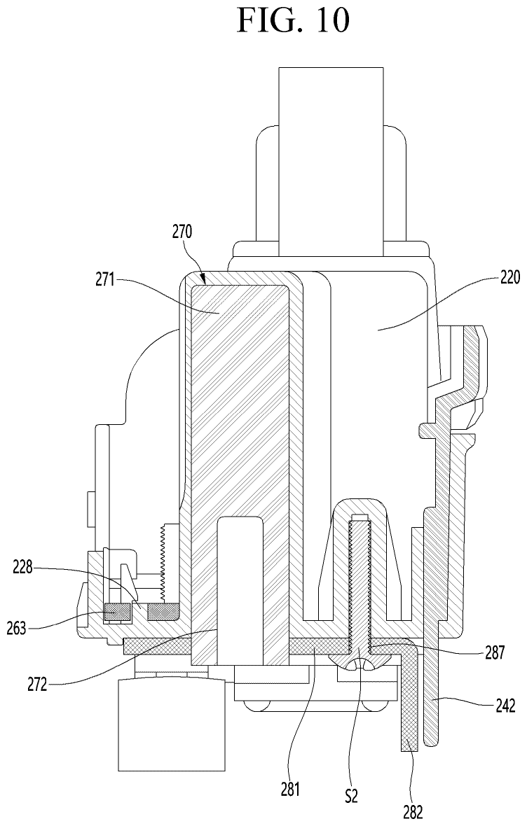

FIG. 7 is a rear perspective view of a door frame showing a state in which a reinforcing plate and a cover plate are coupled to a door frame according to a first embodiment. FIG. 8 is a front perspective view of a door frame showing a state in which a reinforcing plate and a cover plate are coupled to a door frame according to a first embodiment. FIG. 9 is a cross-sectional view taken along line 9-9 of FIG. 7. FIG. 10 is a cross-sectional view taken along line 10-10 of FIG. 7.

Referring to FIGS. 3 to 10, a door frame 220 of the present embodiment may include a handle wall 231 forming a handle. The handle may be formed by recessing one surface of the door frame 220. Of course, the handle wall 231 may be omitted.

The door frame 220 may further include a first wall 234 forming a first space 235 in which the auto closing device 60 is received. The first wall 234 may protrude upward from the door frame 220. The auto closing device 60 may be inserted into the first space 235 formed by the first wall 234. For example, the body 610 may be received in the first space 235 at a lower side of the door frame 220.

The door frame 220 may further include a second wall 236 forming a second space 237 in which the guide member 270 is received. The second wall 236 may protrude upward from the door frame 220. The guide member 270 may be inserted into the second space 237 formed by the second wall 236. For example, the guide member 270 may be received in the second space 236 at a lower side of the door frame 220.

The second wall 236 may be spaced apart from the first wall 234 in a horizontal direction. Based on a left-right direction of the door frame 220, a side surface of the door frame 220 adjacent to the first hinge device 40 among both side surfaces may be referred to as a first side surface 220a. Alternatively, the first wall 234 and the second wall 236 may be formed integrally.

In this specification, the first side surface of the door frame 220 may be replaced with a first side surface of the first door 21. A front surface or a rear surface of the door frame 220 may be replaced with a front surface or a rear surface of the first door 21.

The second wall 236 may be positioned closer to the first side surface 220a of the door frame 220 than the first wall 234. The first wall 234 may be positioned between the second wall 236 and the handle wall 231.

The second space 237 may include a first receiving portion 237a in which the first body 271 is received, and a second receiving portion 237b in which the second body 274 is received. The second receiving portion 237b may extend from a point of the first receiving portion 237a. For example, the second receiving portion 237b may extend from the first receiving portion 237a toward the first space 235.

The door frame 220 may include a front wall 224. A seating groove 225 may be formed at a front wall 224 to allow the body portion 241 of the cover plate 240 to be seated thereon.

The door frame 220 may further include a lower wall 222. The first wall 234 and the second wall 236 may extend from the lower wall 222.

An opening 229 through which the shielding portion 242 passes may be formed in the lower wall 222.

The door frame 220 may further include a rib 221b to limit a movement of the cover plate 240 in a state in which the cover plate 240 is seated on the door frame 220. The rib 221b may be in contact with or close to the body portion 241 of the cover plate 240. The rib 221b may protrude from the lower wall 222. The rib 221b may be spaced apart from the front surface wall 224. Accordingly, a space 221a in which the body part 241 may be positioned may be formed between the rib 221b and the front wall 224.

A coupling hole 227 may be formed in the lower wall 222 to couple the coupling member S3. The coupling hole 227 may be positioned, for example, between the first space 235 and the second space 237, but is not limited thereto.

A first protrusion 226 may be provided at the lower wall 222 to couple to the support plate 280. The first protrusion 226 may, for example, protrude downward from the lower wall 222.

The lower wall 222 may be provided with a second protrusion 228 for coupling to the reinforcing plate 260. The second protrusion 228 may, for example, protrude upward from the lower wall 222.

The lower wall 222 may be provided with a hook 230 for coupling to the reinforcing plate 260. The hook 230 may, for example, extend upward from the lower wall 222.

The cover plate 240 may further include a coupling boss 246 protruding from the body portion 241. The coupling member S3 may be coupled to the coupling boss 246.

When the shield portion 242 passes through an opening 229 of the door frame 220, a portion of the body portion 241 may be seated on the front wall 224, and another portion may be seated on the lower wall 222.

The above reinforcing plate 260 may include a first portion 261, a second portion 263 spaced apart from the first portion 261, and a third portion 266 connecting the first portion 261 and the second portion 263. However, in the present embodiment, a shape of the reinforcing plate 260 is not limited thereto.

The reinforcing plate 260 may be formed of a material having high rigidity. For example, the reinforcing plate 260 may be formed of a metal material.

A first hole 262 may be formed in the first portion 261. A second hole 264 may be formed in the second portion 263. A coupling hole 265 may be formed in the second portion 264.

The first portion 261 may be positioned between the front wall 224 and the second wall 236. The coupling member S3 may be coupled to the first hole 262.

A portion of the second portion 263 may be positioned between the rear surface 220c of the door frame 220 and the first wall 234. Another portion of the second portion 263 may be positioned between the rear surface 220c and the second wall 236.

The second protrusion 228 may be inserted into the second hole 264. The coupling member S2 may be coupled to the coupling hole 265.

The third portion 266 may be positioned between the first wall 234 and the second wall 236.

At least a portion of the height adjusting member 50 may be positioned farther from the first side surface 220a of the door frame 220 than the pin slot 272.

A portion of the pin slot 272 may be positioned closer to a front surface 220b of the door frame 220 than the height adjusting member 50.

Another portion of the pin slot 272 may be positioned closer to a rear surface 220c of the door frame 220 than the height adjusting member 50.

At least a portion of the height adjusting member 50 may be positioned between the pin slot 272 and the auto closing device 60.

The height adjusting member 50 may include a first member 511 coupled to the guide member 270.

A screw thread may be formed on an outer surface of the first member 511. The first member 511 may be coupled to the second body 274 of the guide member 270. A screw thread that interacts with the screw thread of the first member 511 may be formed on a surface forming the coupling slot 276 of the second body 274.

The height adjusting member 50 may further include a second member 512 positioned at one side or end of the first member 511. For example, the second member 512 may be positioned at a lower side of the first member 511.

The second member 512 may be rotatably supported by the support plate 280. For example, the second member 512 may include a first part 513 having a first diameter, a second part 515 having a second diameter, and a third part 517 having a third diameter. The second part 515 may extend from the first part 513. The third part 517 may extend from the second part 515.

The first diameter may be different from a diameter of the first member 511. For example, the first diameter may be greater than the diameter of the first member 511.

The second diameter may be different from the first diameter. For example, the second diameter may be less than the first diameter.

The third diameter may be different from the second diameter. For example, the third diameter may be greater than the second diameter. The first diameter and the third diameter may be the same or different.

The second diameter may be equal to or less than a width or size of the coupling groove 284. The first diameter and the third diameter may be greater than a width or size of the coupling groove 284.

A gap between the first part 513 and the third part 517 may be equal to or greater than a thickness of the plate body 281.

Therefore, the second part 515 of the second member 512 may be inserted into the coupling groove 284 of the support plate 280 at one side of the support plate 280.

In a state in which the second part 515 inserted into the coupling groove 284, at least one of the first part 513 or the third part 517 may be in contact with the plate body 281. By the first part 513 and the third part 517, the height adjusting member 50 may rotate with respect to the support plate 280, and up and down movements can be restricted.

In another aspect, it can also be explained that a groove is formed in a circumferential direction of the second member 512 to form the second part 515.

The second member 512 may be provided with a connection recess 518 to which a tool T used by a user, described later, is connected.

The connection recess 518 may be, for example, a hexagonal groove, but is not limited thereto.

In a state in which the reinforcing plate 260 is seated on the door frame 220, the cover plate 240 may be seated on the door frame 220. Then, the coupling boss 246 may be seated on an upper side of the reinforcing plate 260. That is, the coupling boss 246 may be aligned with the first hole 262.

The support plate 280 may be positioned at a lower side of the door frame 220 with the height adjusting member 50 connected to the support plate 280.

The support plate 280 may include a first hole 287 for coupling member S2 to be coupled and a second hole 288 for coupling member S3 to be coupled.

The coupling member S2 may be coupled to the door frame 220 by passing through the first hole 287.

The coupling member S3 may be coupled to the coupling boss 246 by passing through the second hole 288 of the support plate 280, the coupling hole 227 of the door frame 220, and the first hole 262 of the reinforcing plate 260. That is, the support plate 280, the door frame 220, the reinforcing plate 260, and the cover plate 240 may be connected by a single coupling member S3.

Since the support plate 280 to which the height adjusting member 50 is connected is coupled to the door frame 220, the height adjusting member 50 may move up and down together with the door frame 220.

In this embodiment, the first door 21 may be raised or lowered when the height adjusting member 50 is operated while the guide member 270 is supported on the flange 423 or the extension 412. For example, the door frame 220 can move relative to the guide member 270.

A portion of the first body 271 may be received in the second space 237 (e.g., the first receiving portion 237a). Another portion of the first body 271 may be positioned outside the second space 237. Another portion of the first body 271 may pass through a hole 283 of the support plate 280.

Accordingly, a portion of the pin slot 272 may be positioned in the second space 237 and another portion of the pin slot 272 may be positioned outside the second space 237.

The second body 274 may be received in the second space 237 (for example, the second receiving portion 237b). A vertical length of the second body 274 may be less than a vertical length of the second space 237.

A portion of the second member 512 may be positioned in the second space 237. Another portion of the second member 512 may be positioned outside the second space 237.

For example, the first part 513 may be positioned in the second space 237. The third part 517 may be positioned outside the second space 237. The shielding part 242 may be positioned in front of the third part 517. Accordingly, the third part 517 may be prevented from being exposed to a front side of the first door 21.

In the second body 274, a receiving groove 277 may be formed to receive the second member 512 during a process of the height adjusting member 50 rising. For example, the first part 513 may be received in the receiving groove 277. However, this is not limited thereto, and when the height of the second body 274 is decreased, the receiving groove 277 may be omitted.

Referring to FIG. 9, the third part 517 may be positioned at a lower side of the plate body 281. The connection recess 518 may be formed in the third part 517. A tool used by a user may be connected to the connection recess 518.

In the present embodiment, since the third part 517 of the height adjusting member 50 is exposed to an outside, there is an advantage in that an external exposure of the height adjusting member 50 is minimized.

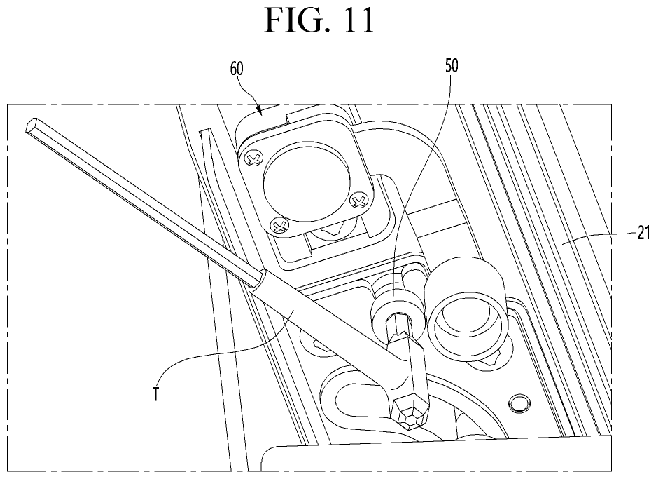

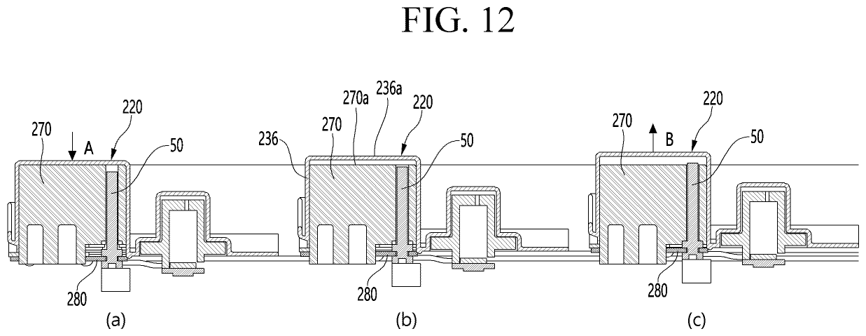

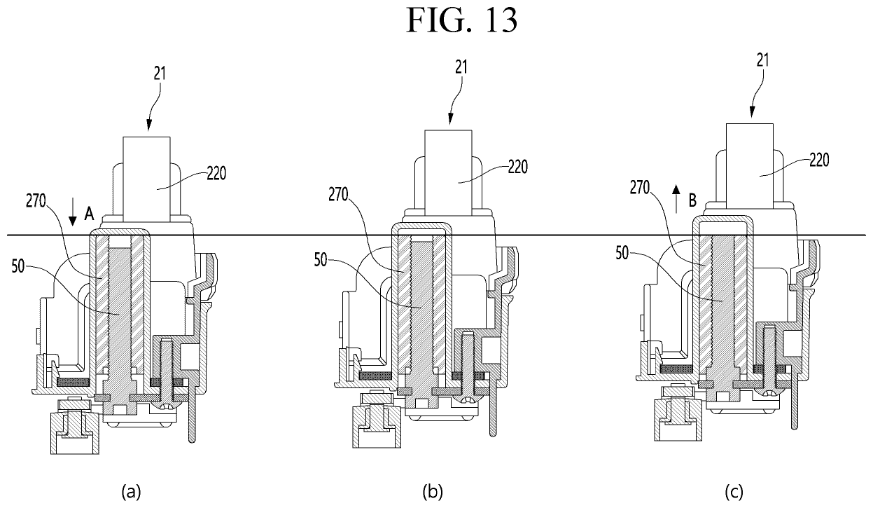

FIG. 11 is a drawing showing a tool connected to a height adjusting member according to a first embodiment. FIGS. 12 and 13 are drawings showing relative positions of a guide member and a door frame while a height of a first door is adjusted according to a first embodiment.

FIG. 12 (a) to (c) are views of a cross-section along line 12-12 in FIG. 2, while FIG. 13 (a) to (c) are views of a cross-section along line 9-9 in FIG. 7 (as FIG. 9). Based on FIG. 12 (b), FIG. 12(a) shows a state in which a height of the first door is lowered, and FIG. 12(c) shows a state in which the height of the first door is increased.

Based on FIG. 13(b), FIG. 13(a) shows a state in which the height of the first door is lowered, and FIG. 13(c) shows a state in which the height of the first door is increased.

Referring to FIGS. 4 to 13, in order to adjust a height of the first door 21, in a state in which the first door 21 is opened, the user can connect the tool T to the connection recess 518 of the height adjusting member 50.

Referring to FIG. 12(b), an upper surface 270a of the guide member 270 may be spaced apart from an upper wall 236a of the second wall 236. Accordingly, a gap exists between the upper wall 236a and the upper surface 270a of the guide member 270, allowing relative movement of the door frame 220 with respect to the guide member 270.

To reduce a height of the first door 21, the tool T can be rotated in one direction (or the first direction). To increase the height of the first door 21, the tool can be rotated in the other direction (or the second direction).

In a state such as FIG. 12(b) and FIG. 13(b), when the tool T is rotated in one direction, the height adjusting member 50 may be rotated in the one direction.

When the height adjusting member 50 is rotated in one direction while the guide member 270 is positioned in the second space 237, the height adjusting member 50 can be rotated with respect to the guide member 270 while a rotation of the guide member 270 is restricted.

Referring to FIG. 12 (a) and FIG. 13 (a), when the height adjusting member 50 rotates in one direction, the height adjusting member 50 moves downward with respect to the guide member 270 due to an interaction between the screw thread of the height adjusting member 50 and the screw thread of the guide member 270.

By a downward movement of the height adjusting member 50, the door frame 220 connected to the height adjusting member 50 moves downward (or lowered) in an A direction.

That is, while a position of the guide member 270 is fixed, the first door 21 moves in the A direction, and the height of the first door 21 decreases, as shown in FIG. 12(a) and FIG. 13(a).

On the other hand, in a state such as FIG. 12(b) and FIG. 13(b), when the tool T is rotated in the other direction, the height adjusting member 50 may be rotated in the other direction.

Referring to FIG. 12(c) and FIG. 13(c), when the height adjusting member 50 is rotated in the other direction, the height adjusting member 50 moves upward with respect to the guide member 270 due to an interaction between the screw thread of the height adjusting member 50 and the screw thread of the guide member 270.

By upward movement of the height adjusting member 50, the door frame 220 connected to the height adjusting member 50 moves upward (or rises) in a B direction.

That is, while the position of the guide member 270 is fixed, the first door 21 moves in the B direction, so that the height of the first door 21 increases, as shown in FIG. 12(c) and FIG. 13(c).

According to this embodiment, the height of the door connected to the height adjusting member 50 is adjusted by rotating the height adjusting member 50, so there is an advantage in that a structure for adjusting the height of the door becomes simple.

According to this embodiment, the door can be automatically closed by the auto closing device during the door closing process, and the height adjusting member 50 for height adjustment is connected to the guide member 270 to which the pin unit is coupled, so that the height adjusting member 50 is compact without interfering with the auto closing device 60.

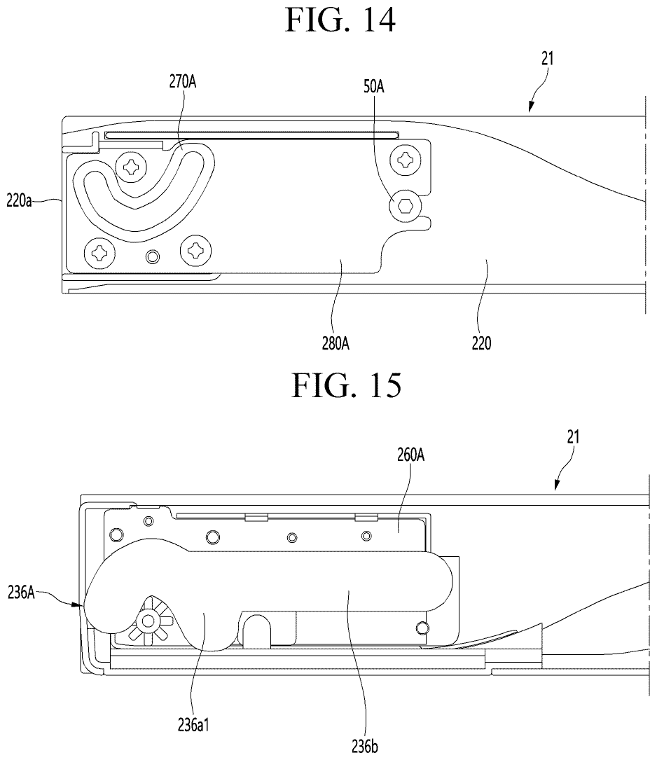

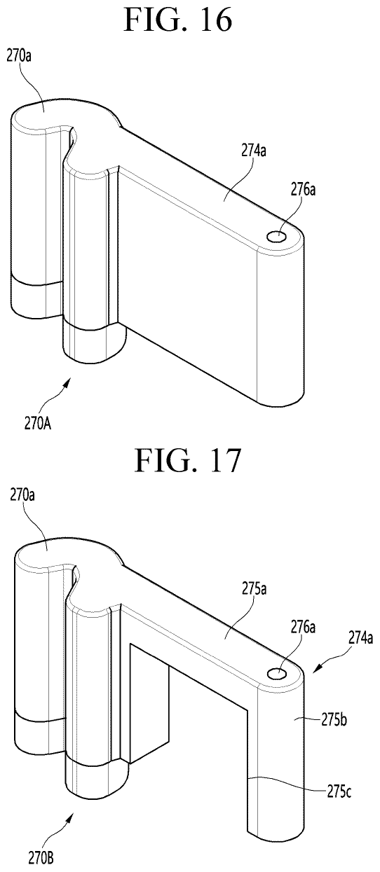

FIG. 14 is a bottom view of a first door showing a position of a height adjusting member according to a second embodiment. FIG. 15 is a plan view of a door frame according to a second embodiment. FIG. 16 is a perspective view of a guide member according to a second embodiment.

This embodiment is identical to the first embodiment in terms of a structure and operation of the height adjusting member, but differs in that a position of a height adjusting member is variable and an auto closing device is omitted. Therefore, only characteristic parts of this embodiment will be described below.

Referring to FIGS. 14 to 16, in the present embodiment, a distance between a height adjusting member 50A and a first side surface 220a of the door frame 220 may be increased.

When the distance between the height adjusting member 50 and the first side surface 220a is increased, sufficient space can be secured to operate the height adjusting member 50A in a state in which the first door 21 is opened, thereby increasing the user's ease of operation.

A guide member 270A of the present embodiment may include a first body 270a and a second body 274a extending from the first body 270a.

Since a shape of the first body 270a is identical to the shape of the first body 271 of the first embodiment, a detailed description thereof will be omitted.

The second body 274a may be formed with a coupling slot 276a for coupling the height adjusting member 50A.

In accordance with a shape of the guide member 270A, the door frame 220 may include a wall 236A that forms a space in which the guide member 270A is received.

The wall 236A may include a first portion 236a1 in which the first body 270a is received, and a second portion 236b in which the second body 274a is received.

A support plate 280A of the present embodiment may have a length that increases compared to the support plate 280 of the first embodiment in response to a positional variation of the height adjusting member 50A.

Around the wall 236A, a reinforcing plate 260A having the same function as the reinforcing plate 260 of the first embodiment but with a changed shape may be positioned.

FIG. 17 is a perspective view of a guide member according to a third embodiment.

Referring to FIGS. 2, 16 and 17, when the auto closing device 60 is added to the first door 21 provided with the guide member 270A of the second embodiment, a shape of the guide member 270A can be changed so that the guide member 270A does not interfere with the auto closing device 60.

A guide member 270B of the present embodiment may include a first body 270a and a second body 274b extending from the first body 270a. The second body 274b may form a space 275c to prevent interference with the auto closing device 60.

That is, the second body 274a may include a first extension portion 275a extending in a horizontal direction from an upper portion of the first body 270a, and a second extension portion 275b extending downward from the first extension portion 275a. A coupling slot 276a may be formed in the second extension portion 275b.

Accordingly, the first extension portion 275a may be positioned at an upper side of the auto closing device 60. At least a portion of the auto closing device 60 may be positioned between the pin slot 272 and the height adjusting member 50A.

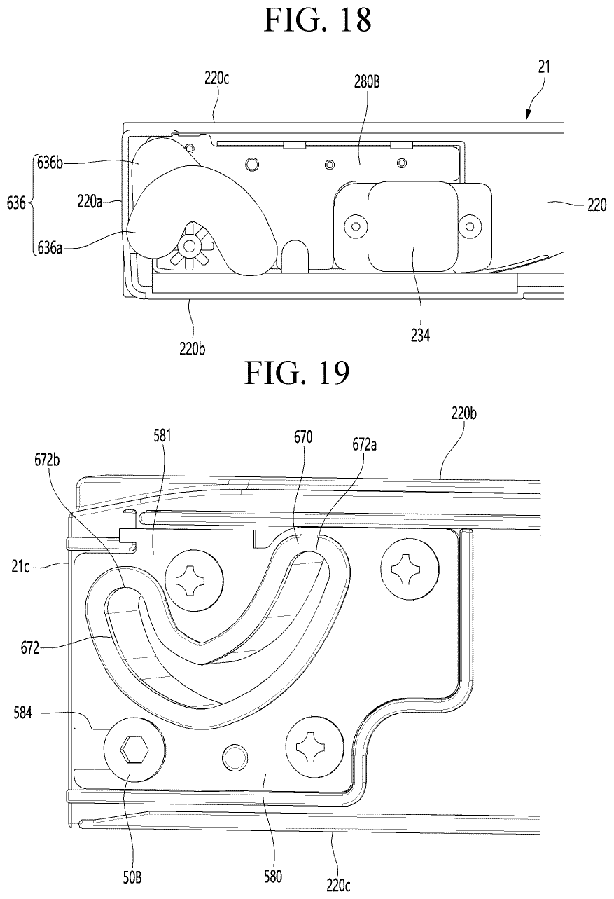

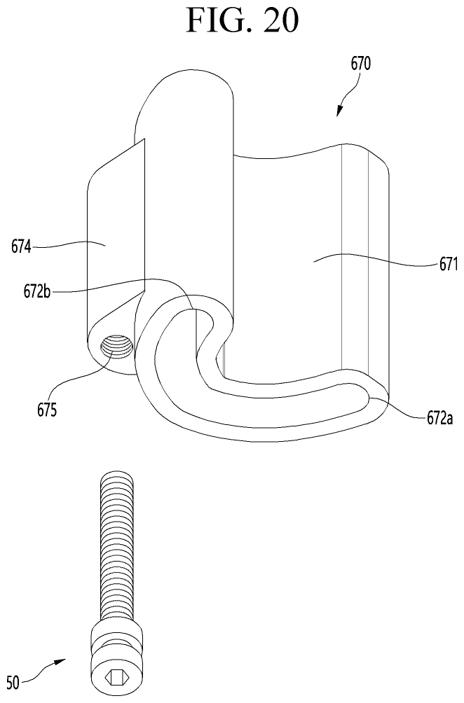

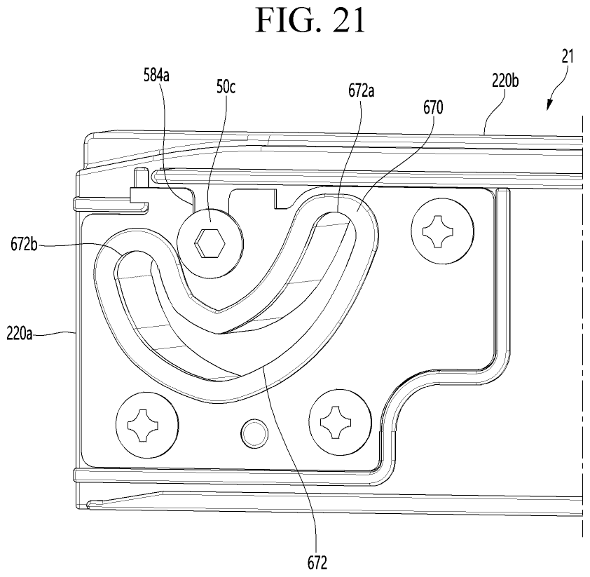

FIG. 18 is a plan view of a door frame according to a fourth embodiment. FIG. 19 is a drawing showing a lower side of a first door according to a fourth embodiment. FIG. 20 is a drawing showing a guide member and a height adjusting member according to a fourth embodiment.

This embodiment is identical to the first embodiment in other respects, except that it differs in a shape of a guide member and a position of a height adjusting member. Therefore, only characteristic parts of this embodiment will be described below.

Referring to FIGS. 18 to 20, a height adjusting member 50B of the present embodiment may be positioned adjacent to a first side surface 220a of the door frame 220.

The height adjusting member 50B of the present embodiment may be positioned adjacent to a rear surface 220c of the door frame 220 than a front surface 220b.

The door frame 220 may include a first wall 234 for receiving the auto closing device 60 and a second wall 636 for receiving a guide member 670.

The guide member 670 may include a first body 671 forming a pin slot 672.

The guide member 670 may further include a second body 674 to which the height adjusting member 50B is rotatably coupled. The second body 674 may, for example, extend in a horizontal direction from the first body 671. A coupling slot 675 may be formed in the second body 674 to which the height adjusting member 50B is coupled.

The pin slot 672 may include a first end 672a with which the first pin 421 contacts or is adjacent when the first door 21 is closed. The pin slot 672 may include a second end 672b with which the second pin 422 contacts or is adjacent when the first door 21 is opened to a maximum opening angle.

The second end 672b may be positioned closer to the first side surface 220a than the first end 672a. The first end 672a may be positioned closer to a front surface 220b of the door frame 220 than the second end 672b.

The second body 674 may be positioned closer to the second end 672b than the first end 672a. The second body 674 may be positioned closer to the first side surface 220a than the first end 672a.

The second body 674 may extend from a point of the first body 671 toward the first side surface 220a or a rear surface 220c of the door frame 220.

The second body 674 may be positioned closer to the rear surface 220c of the door frame 220 than the pin slot 672.

In accordance with a shape of the guide member 670, the second wall 636 may include a first receiving wall 636a in which the first body 671 is received, and a second receiving wall 636b in which the second body 674 is received. A positional relationship between the first receiving wall 636a and the second receiving wall 636b is the same as a positional relationship between the first body 671 and the second body 674.

In addition, a positional relationship between the height adjusting member 50B and surrounding structures is the same as a positional relationship between the second body 674 and surrounding structures, so a detailed description thereof will be omitted.

The first door 21 of the present embodiment may also include a support plate 580. Since a basic shape and coupling method of the support plate 580 are the same as those of the first embodiment, a detailed description thereof will be omitted. However, a position of the coupling groove 584 for coupling the height adjusting member 50B may be changed. The coupling groove 584 may be positioned adjacent to the first side surface 220a of the door frame 220.

FIG. 21 is a drawing showing a lower side of a first door according to a fifth embodiment.

This embodiment is identical to the fourth embodiment in other respects, except that it differs a position of the height adjusting member. Therefore, only characteristic parts of this embodiment will be described below.

Referring to FIG. 21, a height adjusting member 50C of the present embodiment may be positioned closer to a front surface 220b of the door frame 220 than a rear surface 220c of the door frame 220.

A portion of the height adjusting member 50C may be positioned between the first end 672a of the pin slot 672 and the second end 672b of the pin slot 672.

At least a portion of the height adjusting member 50C may be positioned closer to the front surface 220b of the door frame 220 than the second end 672b.

At least a portion of the height adjusting member 50C may be positioned farther from the front surface 220b of the door frame 220 than the first end 672a.

The height adjusting member 50C may be positioned father from the first side surface 220a of the door frame 220 than the second end 672b.

The height adjusting member 50C may be positioned closer to the first side surface 220a of the door frame 220 than the first end 672a.

In the above embodiments, the first door 21 is described as a single door, but alternatively, even if the first door 21 includes a main door connected to the body 10 of the cabinet and a sub door rotatable with respect to the main door, the height adjusting member described above can be used. That is, the height adjusting member can be positioned at various positions at the main door.

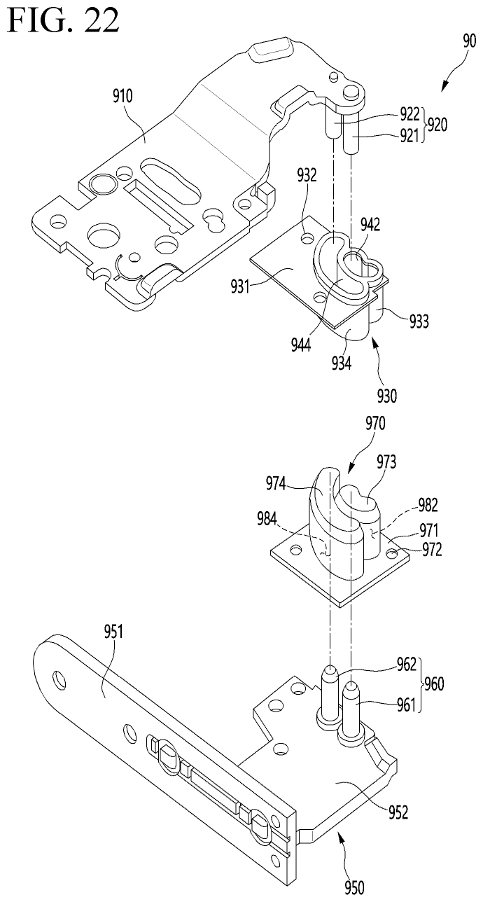

FIG. 22 is a drawing showing a hinge device according to a sixth embodiment.

This embodiment is identical to the previous embodiments in other respects, except that there is a difference in a shape of the guide member. Therefore, only characteristic parts of this embodiment will be described below.

Referring to FIG. 17, a hinge device of the present embodiment may include an upper hinge device 90 and a lower hinge device 950.

The upper hinge device 90 may include a first hinge body 910 and a first pin unit 920.

The first pin unit 920 may, for example, extend from the first hinge body 910 toward the first door 21. The first pin unit 920 may extend downward from the first hinge body 910.

The first pin unit 920 may include a first pin 921 and a second pin 922. The first pin 921 and the second pin 922 may be spaced apart from each other in the first hinge body 910.

A basic shape and function of the first pin 921 and the second pin 922 are the same as the first pin and the second pin of the first embodiment, so a detailed description thereof will be omitted.

The upper hinge device 90 may include a first guide member 930. The first guide member 930 may be provided on the first door 21. The first guide member 930 may form a first pin slot.

The first pin slot may include a first slot 942 for receiving the first pin 921 and a second slot 944 for receiving the second pin 922. The first slot 942 and the second slot 944 may be spaced apart from each other and separated from each other.

The first guide member 930 may include an extension 931 for being connected to the first door 21. A coupling hole 932 for a coupling member to pass through the extension 931 may be formed. The coupling member may be connected to the first door 21 by passing through the coupling hole 932.

The first guide member 930 may include a first body part 933 forming the first slot 942 and a second body part 934 forming the second slot 944. The first body part 933 and the second body part 934 may extend from the extension 931.

A lower hinge device 950 of the present embodiment may include a second hinge body and a second pin unit 960.

The second hinge body may include, for example, a coupling portion 951 coupled to the body 10 of the cabinet, and an extension 952 extending from the coupling portion 951. The second pin unit 960 may be provided in the extension 952.

The second pin unit 960 may, for example, extend upward from the extension 952.

The second pin unit 960 may include a first pin 961 and a second pin 962. The first pin 961 and the second pin 962 may be spaced apart from the extension 952.

The lower hinge device 950 may further include a second guide member 970. The second guide member 970 may be provided at the first door 21.

The second guide member 970 may form a second pin slot.

The second pin slot may include a first slot 982 in which the first pin 961 is received, and a second slot 984 in which the second pin 962 is received. The first slot 982 and the second slot 984 may be spaced apart from each other and separated from each other.

The second guide member 970 may include an extension 971 coupled to the first door 21. A coupling hole 972 through which a coupling member passes may be formed in the extension 971. The coupling member may be coupled to the first door 21 by passing through the coupling hole 942.

The second guide member 970 may include a first body part 973 forming the first slot 982 and a second body part 974 forming the second slot 984. The first body part 973 and the second body part 974 may extend from the extension 971.

Even in the present embodiment, a rotation center of the first door 21 may be moved by the upper hinge device 90 and the lower hinge device 950.

Although above description only describes the invention applied to a refrigerator, the invention can be applied to a cabinet for any home appliance, e.g. to a clothes treatment device such as a refresher, styler, washing machine or dryer.

What is claimed is:

1. A cabinet comprising:
a cabinet body having a storage space;
a door that opens and closes the storage space;
a hinge device configured to allow the door to rotate relative to the cabinet; and
a height adjusting member configured to adjust a height of the door,
wherein the hinge device includes:
a hinge body installed at the cabinet,
a pin unit provided at the hinge body, and
a guide member provided at the door and forming a pin slot in which the pin unit is received,
wherein the height adjusting member is movably coupled to the guide member,
wherein, when the height adjusting member moves in a first direction, a height of the door is decreased, and
wherein, when the height adjusting member moves in a second direction, the height of the door is increased.

2. The cabinet of claim 1,
wherein during a door opening process, relative positions of the pin slot and the pin unit are changed and a rotation center of the door is moved.

3. The cabinet of claim 1,
wherein the guide member includes:
a first body in which the pin slot is formed, and
a second body including a coupling slot to which the height adjusting member is coupled,
wherein a screw thread is formed on an outer circumferential surface of the height adjusting member, and
wherein a screw thread that interacts with the screw thread of the height adjusting member is formed on a surface forming the coupling slot.

4. The cabinet of claim 1,
wherein, when a side surface of the door closest to the hinge device among both side surfaces of the door is referred to as a first side surface, and
wherein at least a portion of the height adjusting member is positioned farther from the first side surface of the door than the pin slot.

5. The cabinet of claim 4,
wherein a portion of the pin slot is positioned closer to a front surface of the door than the height adjusting member, and
wherein another portion of the pin slot is positioned closer to a rear surface of the door than the height adjusting member.

6. The cabinet of claim 1, further comprising:
an auto closing device provided at one side of the guide member of the door and to provide closing force to the door during a door closing process.

7. The cabinet of claim 6,
wherein at least a portion of the height adjusting member is positioned between the pin slot and the auto closing device, or
wherein at least a portion of the auto closing device is positioned between the pin slot and the height adjusting member.

8. The cabinet of claim 1,
wherein the height adjusting member is positioned closer to a rear surface of the door than the pin slot.

9. The cabinet of claim 8,
wherein the guide member includes:
a first body in which the pin slot is formed, and
a second body including a coupling slot to which the height adjusting member is coupled, and
wherein when a side surface of the door closest to the hinge device among both side surfaces of the door is referred to as a first side surface, the second body extends from a point on the first body toward the first side surface or a rear surface of the door.

10. The cabinet of claim 1,
wherein the pin unit includes a first pin and a second pin,
wherein the pin slot includes a first end with which the first pin contacts or is adjacent in a state in which the door is closed, and
wherein a second end with which the second pin contacts or is adjacent in a state in which the door is opened to a maximum opening angle, and
wherein a portion of the height adjusting member is positioned between the first end and the second end.

11. The cabinet of claim 10,
wherein the first end is positioned closer to a front surface of the door than the second end,
wherein at least a portion of the height adjusting member is positioned closer to the front surface of the door than the second end, and
wherein at least a portion of the height adjusting member is positioned farther from the front surface of the door than the first end.

12. The cabinet of claim 1,
wherein the door further includes a support plate coupled to the door and rotatably supporting the height adjusting member.

13. The cabinet of claim 12,
wherein the height adjusting member includes a first member coupled to the guide member, and
a second member rotatably supported by the support plate, and
wherein the support plate includes a coupling groove formed by recessing one surface of the support plate to allow the second member to be coupled.

14. The cabinet of claim 13,
wherein the second member includes:
a first part having a first diameter,
a second part extending from the first part and having a second diameter, and
a third part extending from the second part and having a third diameter, and
wherein the second part is received in the coupling groove,
the first diameter and the third diameter are greater than the second diameter, and
the first diameter and the third diameter are greater than a width or size of the coupling groove.

15. The cabinet of claim 12,
wherein the support plate includes a hole through which the guide member passes.

16. The cabinet of claim 12,
wherein the support plate includes a stopper that restricts a rotation of the door when the door is opened at a certain angle.

17. The cabinet of claim 12,
wherein the door further includes a reinforcing plate connected to a coupling member passing through the support plate.

18. A cabinet comprising:
a cabinet body having a storage space;
a door that opens and closes the storage space;
a hinge device configured to allow the door to rotate relative to the cabinet;
a height adjusting member configured to adjust the height of the door; and
an auto closing device configured to provide a closing force to the door during a door closing process,
wherein the hinge device includes:
a hinge body installed at the cabinet,
a pin unit provided at the hinge body, and
a guide member provided at the door and forming a pin slot in which the pin unit is received,
wherein the auto closing device includes:
a body installed at the door at one side of the guide member, and
a lever rotatable with respect to the body and interacting with the hinge body, and
wherein at least a portion of the height adjusting member is positioned closer to the pin slot than a rotation center of the lever.

19. A cabinet comprising:
a cabinet body having a storage space;
a door that opens and closes the storage space;
a hinge device configured to allow the door to rotate relative to the cabinet;
a height adjusting member configured to adjust the height of the door; and
an auto closing device configured to provide a closing force to the door during a door closing process,
wherein the hinge device includes:
a hinge body installed at the cabinet,
a pin unit provided at the hinge body, and
a guide member provided at the door and forming a pin slot in which the pin unit is received,
wherein the auto closing device includes:
a body installed at the door at one side of the guide member, and
a lever rotatable with respect to the body and interacting with the hinge body, and
wherein at least a portion of the auto closing device is positioned between the height adjusting member and the pin slot.

20. The cabinet of claim 19,
wherein the height adjusting member is movably coupled to the guide member.
